(19) United States
(12) Patent Application Publication
(10) Pub. No.: US 2007/0038565 A1
(43) Pub. Date: Feb. 15, 2007

(54) METHOD AND SYSTEM FOR CONTACTLESS POINT-OF-SALE TRANSACTION MANAGEMENT

(75) Inventors: Thomas R. Bartz, Lynden, WA (US); Thomas M. Ryan, Lynden, WA (US); Brent K. Droullard, Lynden, WA (US); Allen M. Butler, Sammamish, WA (US); Johann I. Johannsson, Bellevue, WA (US)

Correspondence Address: LEE & HAYES, PLLC, 421 W. RIVERSIDE AVE, STE 500, SPOKANE, WA, 99201, US

(73) Assignee: ACCELITEC, INC., Bellingham, WA (US)

(21) Appl. No.: 11/464,691

(22) Filed: Aug. 15, 2006

Related U.S. Application Data
(60) Provisional application No. 60/708,895, filed on Aug. 15, 2005.

(51) Int. Cl. G06Q 40/00; G06Q 20/00

(52) U.S. Cl. 705/41; 705/18

(57) ABSTRACT

A payment processing and transaction management system includes one or more devices at the point-of-sale for reading a contactless payment tag and verifying the validity of its use. Payment options can be written to memory within the tag or stored on a host accessible by point-of-sale devices when the payment tag is presented. The devices facilitate controlled use of tags to access prepaid funds, automated clearing house funds, credit card payments, or other sources of payment. Devices at the point-of-sale provide for validation by a customer entering a personal identification number or by a cashier by verifying a photograph of an authorized user associated with the tag. Customers and merchants can specify and modify limitations on how the tag can be used. Customers can request e-mail or text message alerts when the tag is used or used in a way that violates limitations on the use of the tag.

### RELATED APPLICATION

This application claims the priority of U.S. Provisional Patent Application Ser. No. 60/708,895, filed on Aug. 15, 2005. Priority is hereby claimed to this previously-filed application under 35 U.S.C. section 120

### TECHNICAL FIELD

This invention relates to payment systems, and more particularly, to transactions involving contactless payment systems.

### BACKGROUND

With the passage of time, increasingly fewer consumers use cash or checks in retail transactions. Instead, consumers frequently use credit cards. Credit cards allow consumers to dispense with the time or forethought involved in obtaining cash. Further, unlike cash, if a credit card is lost or stolen, the consumer may suffer little or no risk. Also, unlike checks, credit cards also allow consumers to complete a transaction quickly, without writing a check or presenting identification to authenticate the check. In addition, many merchants that refuse to accept checks gladly will accept credit cards because the merchant can instantly determine whether the consumer has access to sufficient funds to support the transaction.

For all the apparent advantages of using credit cards, however, credit cards have a number of disadvantages. It is widely known that excessive and careless use of credit cards has resulted in countless people ruining their financial situations. Many consumers owe thousands of dollars to credit card companies at staggering rates of interest. Consumers who accrue large balances ruin their credit ratings or, even worse, may have to declare bankruptcy.

What is less widely known, however, is the disadvantage to merchants in allowing consumers to conduct transactions using credit cards. Credit card companies charge significant transaction fees for every credit transaction. These transaction fees, which may seem small on a per-transaction basis, represent a huge cost. For example, some studies indicate that transaction fees represent the second-highest cost paid by retail gasoline dealers, second only to retail estate expenses. In other words, gasoline dealers pay more in credit card transaction fees than they pay their employees. These transaction fees not only cut into merchants' profits, but also eventually are passed on to consumers in the form of higher prices.

Despite the revenue that credit card companies earn from both consumers and merchants, credit card companies do little to help consumers or merchants. In the case of consumers, credit card companies provide virtually no security to consumers to protect them when their cards are stolen or illicitly duplicated. Data encoded on the magnetic stripe disposed on credit cards usually is unencrypted, making the data very easy to read and/or duplicate. The only security typically provided to consumers is the signature block on the back of the cards. Even if a merchant checks the signature block on the back of a stolen card, the signature may easily be forged to fool a merchant. Of course, if a person should illegally duplicate a credit card, that person can supply the signature in his or her own handwriting, circumventing the need for forgery.

Even though the consumer ultimately may not be personally liable for fraudulent charges, the consumer may have difficulty in proving the charges were not legitimate and in repairing their credit histories. Moreover, consumers may not be aware of the unauthorized use of their accounts until they receive their monthly statements, potentially weeks after the fraudulent transactions took place.

Credit card companies also do little for merchants. If a merchant wants to work with a credit card company, the merchant must purchase the necessary hardware and communications facilities to enable the credit card transactions. The credit card companies do nothing to help the merchants learn about their customers' buying habits or provide any other information in exchange for the huge transaction fees charged.

### SUMMARY

A payment processing and transaction management system includes one or more devices at the point-of-sale for reading a contactless payment tag and verifying the validity of the use of the payment tag. Payment options can be written to memory within the payment tag or stored on a host accessible by point-of-sale devices when the payment tag is presented. The devices facilitate controlled use of payment tags to access prepaid funds, automated clearing house funds, or credit card payments.

Devices at the point-of-sale provide for validation by a customer entering a personal identification number or validation by a cashier by checking a photograph of those authorized to use the payment tag. Customers and merchants can specify and modify limitations on how the payment tag can be used. Customers can access and modify options remotely via computer. Customers can request e-mail or text message alerts indicating when the payment tag is used, or when the payment tag is used in a way that violates predetermined limitations on the use of the payment tag.

### BRIEF DESCRIPTION OF THE DRAWINGS

The detailed description is described with reference to the accompanying figures. In the figures, the left-most digit of three-digit reference numbers and the two left-most digits of four-digit reference numbers identify the figure in which the reference number first appears. The use of the same reference numbers in different figures indicates similar or identical items.

FIG. 1 illustrates devices for facilitating contactless payment at a point of sale using a contactless payment tag, including a control unit and a customer terminal.

FIG. 2 is a functional block diagram of the customer terminal of FIG. 1.

FIG. 3 is a functional block diagram of the control unit of FIG. 1.

FIG. 4 is a network diagram illustrating interaction of the control unit and the customer terminal with systems used in managing transactions and customer options.

FIG. 5 is a series of representative screens displayable by the control unit interactive display used in facilitating and managing transactions.

FIG. 6 is a series of representative screens displayable by the customer terminal display in facilitating transactions.

FIGS. 7-12 are flow diagrams illustrating modes of operation of the control unit and the customer terminal in facilitating and managing transactions.

FIG. 13 is a screen presented by a computing system usable by a customer to manage properties associated with a payment tag.

FIG. 14 is a text-enabled mobile telephone displaying a message received regarding usage of a payment tag associated with the mobile phone user.

FIG. 15 is a block diagram of a computing system usable in facilitating and managing transactions and payment options.

### DETAILED DESCRIPTION

Control Unit and Customer Terminal for Use with a Contactless Payment Tag

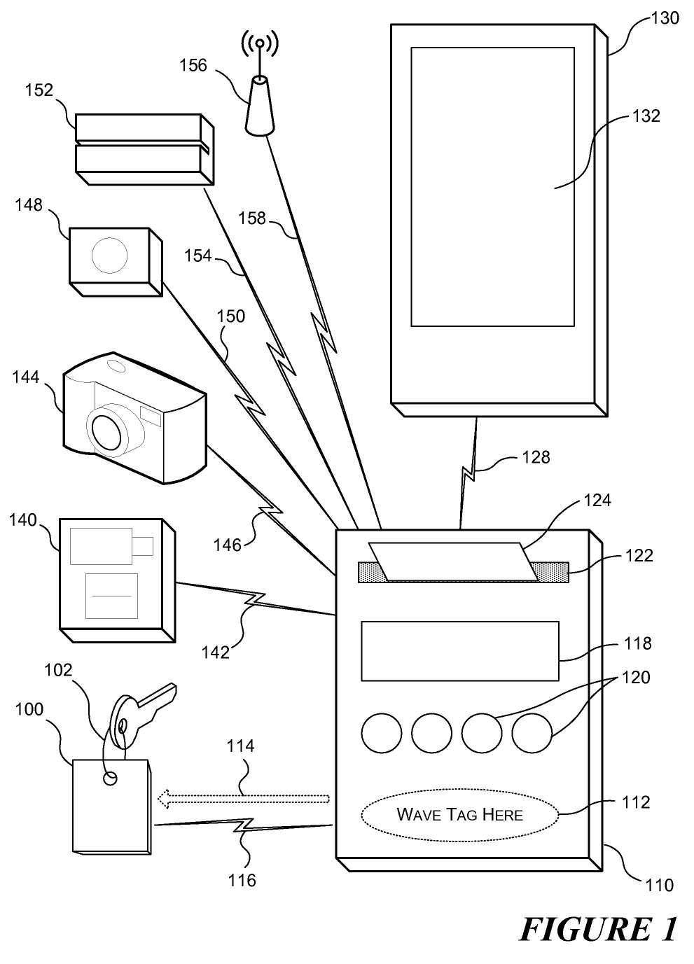

FIG. 1 illustrates a point-of-sale environment for facilitating and managing contactless payments and related transactions. A customer carries a contactless payment tag 100. The payment tag, in one embodiment, includes an externally powered memory device and radio transponder, such as a rewritable radio frequency identification (RFID) device. In one embodiment, the payment tag 100 is a small, relatively flat object that may be attached, for example, to a keychain 102 for the sake of convenience. Alternatively, the payment tag 100 may be attached to a mobile telephone, a watchband or other wristband, or some other portable device so that the payment tag 100 is conveniently coupled with an article regularly carried by the customer.

Further alternatively, the payment tag 100 may be coupled with or integrated into an additional portable device that a customer may be willing to or happy to carry. For example, the payment tag 100 could be coupled with or joined to a flash memory device, such as a universal serial bus (USB) drive that is commonly used by people to transport data files between computers. Also, the payment tag could be coupled with or integrated into eyeglass or sunglass cases, pocket knives, bottle openers, and a number of other objects that people might be willing to or happy to carry with them because of the function or functions they offer apart from the functionality offered by the payment tag 100 itself.

Using the payment tag 100, a customer engages a customer terminal 110 to pay for transactions. Beneath a marking 112 indicating to a customer where the payment tag 100 should be disposed is a transponder reader/writer (not shown in FIG. 1). In an embodiment where the transponder utilizes RFID technology, the customer terminal 110 generates a magnetic flux 114 that, by virtue of induction coils associated with the transponder, generates electrical current to power the transponder. Upon the electrical current being generated, the transponder transmits a signal 116 that is receivable by the transponder reader/writer.

The signal 116 carries information about the customer. The signal 116 also may include a unique alphanumeric identifier that is conveyed to a host, described further below, that serves as a key to secure access to the customer's record. Analogous to the information provided by magnetic stripe on a credit card upon being swiped through an appropriate reader, the signal 116 generated by the transponder provides account and security information to facilitate the customer's payment for the transaction, as is described further below. In addition, the transponder reader/writer is operable to rewrite the memory map included in the transponder to provide security updates, debit a prepaid fund total, or to perform other functions.

The customer terminal 110 also includes a display 118 that provides information to the customer. For example, the display 118 may present instructions to the customer about how to complete the transaction, such as by providing labels for function keys 120 arrayed below the display. The function keys 120, as indicated by labels on the display, may indicate to the customer which of the function keys to press to generate or decline a receipt, to confirm or reject the proposed transaction amount, to specify a payment mechanism, and perform other functions.

The customer terminal 110 also includes a printer 122, such as a thermal printer, dot matrix printer, or some other type of printer, to generate various types of documents 124. The documents 124 that may be generated include customer receipts, daily transaction reports, customer loyalty coupons, reward vouchers, and other documents.

The customer terminal 110 communicates via a communications link 128 with a control unit 130. The communications link may include a serial cable, a universal serial bus (USB) cable, a wireless connection such as an Institute for Electrical and Electronic Engineers (IEEE) 802.01 specification connection, or another type of communications link.

The control unit 130, in one mode, includes a multi-function interactive display 132, such as a touch sensitive liquid crystal display (LCD). The interactive display 132 is programmable to present touch-keys to allow a cashier to enter transaction amounts, to allow a customer to enter a personal identification number (PIN), to present customer or transaction validation information, to manage the transaction system, and perform other functions. The control unit 130 transmits directions to the customer terminal 110 via the same communications link 128 used to receive information from the customer terminal 110.

The control unit 130 also includes a wide area network (WAN) and/or local area network (LAN) interface that allows the control unit 130 to send transaction information and receive transaction information from other systems to facilitate payments and other functions, as is described further below.

The customer terminal 110 and the control unit 130 may be combined into a signal unit, or manifested as separate units. One advantage of maintaining the customer terminal 110 and the control unit 130 as separate devices is that one control unit may be used to control a plurality of customer terminals. A further advantage to separately embodying the customer terminal 110 and the control unit 130 is that the customer terminal 110 may be positioned remotely from the control unit 130. Thus, for example, the customer terminal 110 can be disposed on the outside of a fast foot restaurant to allow a customer to use a payment tag 100 to initiate payment for a transaction, which a cashier inside the restaurant can manipulate the control unit 130 to enter the transaction amount, view customer verification information, and perform other functions. Whether the customer terminal 110 and the control unit 130 are embodied in separate units or a single unit, the device or devices can be mounted and/or positioned to allow the input device or devices to be accessed by both a customer and a cashier to perform their respective functions.

In additional embodiments of the customer terminal 110 and the control unit 130, peripherals can be attached to the one of the point of sale devices. For example, an optical scanner 140 may be connected via a wired or wireless communication link 142 to read bar codes or scan drivers' licenses. An optical scanner 140 facilitates distribution of payment tags 100 at the point of sale. Coupons may be sent to prospective customers that with a bar code including name and address information to facilitate rapid enrollment in the program. In addition, by scanning a driver's license, the driver's license photograph of the new customer can be associated with the customer's record for transaction validation, as is further described below. Similarly, a digital camera 144 may be coupled to the customer terminal 110 via a communications link 146 to allow a photograph to be taken of a customer, with the current photograph being associated with the customer's record.

Other peripherals may be coupled to one of the point-of-sale devices via a communications link. For example, a biometric reader 148 may be coupled to the customer terminal 110 via a communications link 150 to receive thumbprint or fingerprint scans to provide rapid, convenient verification of whether the person presenting the payment tag 100 is authorized to use the payment tag. In addition, a magnetic stripe reader 148 may be coupled to the customer terminal via a communications link 150 to allow customers to perform transactions using conventional credit or debit cards without the merchant having to maintain an additional credit card/debit card payment device. Further, a near field communications device 156, such as a Bluetooth device, may be coupled to the customer terminal 110 via a communications link 158 to enable other functions, such as transferring ring tones to portable devices or music files to a portable music player. Ring tones and music files may be prizes in promotions orchestrated by the merchant, or the ring tones and music files may be purchased from the merchant. Alternatively, the tag reader/writer, further described below, itself may serve as a near field communications device to support the transfer of electronic files to customer devices.

In FIG. 1, peripherals such as the scanner 140, the camera 144, the biometric reader 148, the magnetic stripe reader 152, and the near field communications device 156, are depicted as being in communication with the customer terminal 110. However, as is described further below, the customer terminal 110 may itself be configured as a peripheral to the control unit 130, such that the customer terminal 110 will have only limited logic capabilities. In fact, some of the elements and functions of the customer terminal 110 may be replaced by existing point-of-sale devices or subsumed within the control unit 130. Accordingly, in other embodiments of the payment and transaction management system, some or all of the peripheral devices may be in communication with the control unit 130, rather than in communication with the customer terminal 110.

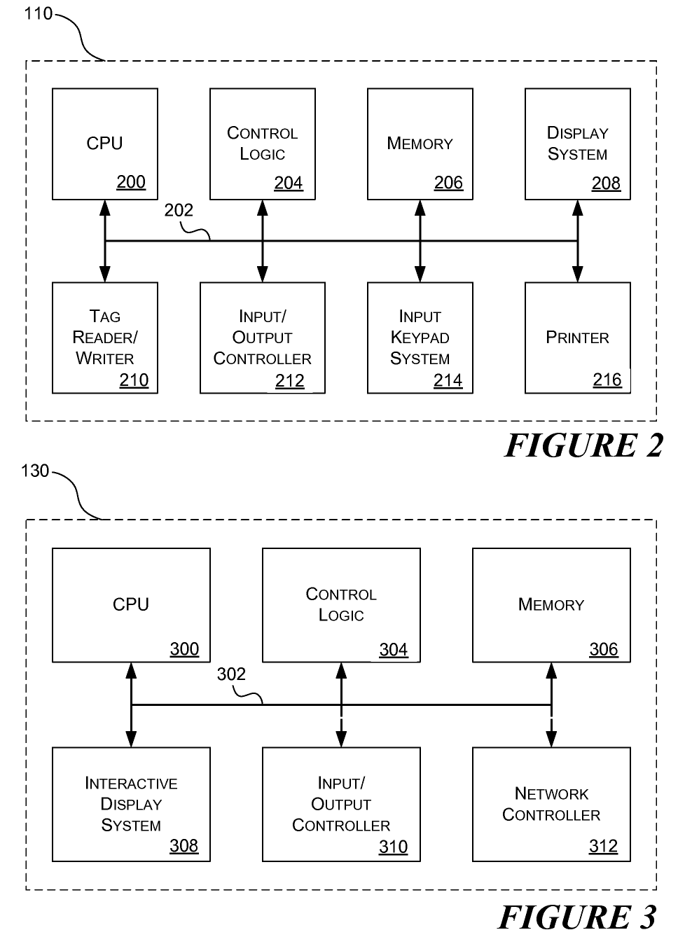

FIG. 2 is a functional block diagram of an embodiment of the customer terminal 110. In one embodiment, the customer terminal 110 includes a central processing unit (CPU) 200 that communicates over a bus 202 with a plurality of other devices. However, in other embodiments, because the customer terminal 110 is operatively coupled to the control unit 130, the customer terminal 110 and the control unit 130 both may be controlled by a shared CPU. The customer terminal 110 includes control logic 204 that includes read-only memory containing the operating system and application code for operating the customer terminal 110, as well as memory access and other control logic used for operating the customer terminal 110.

The customer terminal 110 also includes system memory 206 usable by the customer terminal to maintain data for facilitating operation of the customer terminal 110. The memory 206 includes random access memory like that used in other computing devices to temporarily store data which transactions are being handled and managed, computations are performed, and similar functions. A display system 208 includes both the display 118 (FIG. 1) and supporting control logic to allow characters and other data to be presented to a customer via the display 118.

A tag reader/writer 210, as previously described, in one embodiment both generates a field that remotely powers a payment tag 100 (FIG. 1) and exchanges information with the payment tag. In one embodiment, only a tag reader may be employed, to read identifying information about the customer to whom the tag was assigned. In another embodiment, the tag reader/writer 210 also allows for the memory map in the transponder included in the payment tag to be rewritten. For example, new security or configuration information may be written to the memory map to address security concerns, write revised customer options to the transponder, debit a prepaid funds total stored on the transponder, or perform similar functions.

The input/output controller 212 is a communications subsystem that permits the customer terminal 110 to communicate with the control unit 130. As previously described, the input/output controller 212 may support serial communication, USB communication, wireless communication, or another form of communication with the control unit 130. The input keypad system 214 includes buttons, such as membrane-type switches, as well as supporting control logic to scan the keypad and register input. The printer 216 is a thermal printer or another type of printer that generates documents at the point-of-sale, including customer receipts, transaction reports, and other documents as previously described. Although not shown in FIG. 2, the customer terminal 110 also includes a power supply, or may share a power supply with the control unit, to power the components included in the customer terminal 110, as is widely understood in the art.

FIG. 3 is a functional block diagram of an embodiment of the control unit 130. The control unit 130 includes a central processing unit (CPU) 300 that communicates over a bus 302 with a plurality of other devices. However, as previously described, in an alternative embodiment, the control unit 130 may share a CPU with the customer terminal 110. The control unit 130 also includes control logic 304 that includes read-only memory containing the operating system and application code for operating the control unit 110, as well as memory access and other control logic used for operating the control unit 130.

The control unit 130 also includes system memory 306 usable by the control unit 130 to maintain data for facilitating operation of the control unit 130. The memory 306 includes random access memory like that used in other computing devices to temporarily store data which transactions are being handled and managed, computations are performed, and similar functions.

An interactive display system 308 includes both the interactive display 132 (FIG. 1) and supporting control logic to allow characters, images, and other data to be presented to a cashier or a customer via the interactive display 132. The interactive display system 132 also includes supporting control logic to read input from the interactive display 132, such as keypad touches, stylus input such as a signature, and other information. Operation of touch-sensitive and other types of interactive display technologies, such as those used on currently used point-of-sale terminals, handheld computers, personal digital assistants, and other such devices, are widely understood in the art.

In input/output controller 310 permits the control unit 130 to communicate with the customer terminal 110 via its own input/output controller 212 to exchange information relating to customer transactions. Again, as previously described, the input/output controller 310 may support serial, USB, wireless, or other communication links to allow the control unit 130 to exchange information with the customer terminal 110.

A network controller 312 permits the control unit 130 to exchange information with a wide area network or local area network to access a host computer and other resources, such as payment systems, to facilitate transactions. The network controller 312 may be an Ethernet controller coupled with a broadband communications service. The network controller 312 also may include a modem permitting dial-up access to external resources. The network controller 312 also may include a wide-area wireless connection, or support any other available form of network communication to allow the control unit 130 to engage external resources.

Although not shown in FIG. 3, the control unit 130 also includes a power supply regulated to power the components included in the customer terminal 130, as is widely understood in the art.

As previously described, in other embodiments, the customer terminal 110 may be configured as a peripheral device to the control unit 130. Accordingly, while the customer terminal 110 may be embodied as a device separate from the control unit 130, at least some of the logic functions performed by the customer terminal 110 actually may be performed by the control unit 130. Thus, for example, other than a microprocessor and memory that may be included, for example, in the display system 208, tag reader/writer 210, input keypad system 214, or printer 216, there may be no CPU or system memory included within the customer terminal 110. In such an embodiment, functions of input/output devices such as the display system 208, tag reader/writer 210, input keypad system 214, or printer 216, may be supported by the CPU 300, control logic 304, and/or system memory 306 of the control unit 130. Further alternatively, instead of operational components such as the CPU, memory, control logic, network interface, and similar components supporting both the customer terminal 110 and the control unit 130 residing in the control unit 130, the operational components supporting both the customer terminal 110 and the control unit 130 might reside in the customer terminal 110, with the control unit 130 functionally operating as a peripheral input/output device of the customer terminal 110.

In addition, in an embodiment where the customer terminal 110 and the control unit 130 are combined in a single unit, it will be appreciated that many unnecessary or duplicative components could be eliminated. For example, in a combined customer terminal/control unit, only one CPU, bus, control logic, and system memory would be needed. In addition, a single display system and/or input could be used, thus, for example, the display system 208 (FIG. 2) and the input keypad system 214 of the customer terminal 110 could be eliminated, with its functions being performed by the interactive display system 308. In addition, the input/output controller 212 of the customer terminal 110 and the input/output controller 310 of the control unit 130, which in the embodiments shown exist only to permit communication between the customer terminal and the control unit, both would be eliminated.

Customer Terminal/Control Unit in a Transaction Network

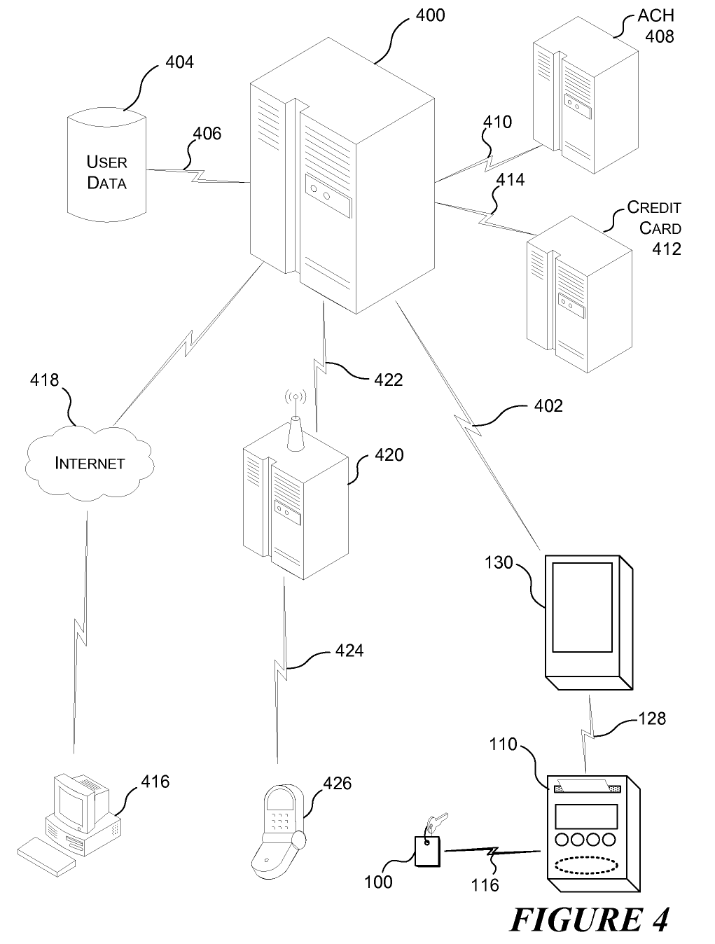

FIG. 4 illustrates how the customer terminal 110 and the control unit 130 operate within an embodiment of a network used to facilitate and manage transactions. For purposes of FIG. 4, and all remaining discussion of the customer terminal 110 and the control unit 130, it is assumed that the customer terminal 110 and the control unit 130 are embodied as separate devices that communicate over a communications link 128.

For example, a customer presents a payment tag 100 at a customer terminal 110 to pay for a purchase. The customer terminal 110 provides the information stored in the payment tag to the control unit 130. The customer may choose to pay for the transaction with funds accessed via an automated clearing house (ACH) transaction. Because ACH transactions are much less expensive to the merchant, the merchant may offer discounts, customer loyalty rewards, or other benefits to a customer opting to authorize an ACH transaction. Alternatively, if the customer knows he or she is low on funds in his or her bank account, the customer may opt to pay for the transaction using a credit card account associated with the payment tag.

Once the control unit 130 receives data from the customer terminal 110 the customer information and payment preferences, the control unit 130 accesses a host 400 over a communications link 402. In one embodiment, the communications link 402 preferably is a virtual private network (VPN) formed over a dial-up or broadband communications line to provide data security for both the customer and the merchant. The host 400, as needed, accesses user/customer data storage 404 over a communications channel 406.

If the customer has elected to make an ACH transaction, the host 400 accesses an ACH service 408 over a communications link 410 to withdraw the funds from the customer's account to pay for the transaction. Alternatively, if the customer has elected to pay for the transaction using a credit card account, the host 400 will access the credit card system 412 over a communications link 414 to retrieve the cost of the transaction (less transaction fees charged by the credit card company).

In addition to the external systems for arranging payment, such as the ACH system 408 and the credit card system 412, the host 400 itself may maintain prepayment records if a customer elects to associate a payment tag 100 with a quantity of prepaid funds. The balance of prepaid funds can be maintained in the memory of the payment tag 100, or stored at the host 400.

Another advantage of the payment and transaction management system is that customer loyalty programs, such as discounts, accumulated rebates, and point systems that allow the points to be redeemed for merchandise, can be integrated with the payment system. Many customer loyalty programs offered by grocery stores, book stores, department stores, and other establishments require that members of the program carry a card or a keytag bearing a bar code or another identifier that is provided to the merchant with each transaction. Unfortunately, these loyalty programs add another step to the transaction because providing the loyalty program card or tag is an additional step beyond the step of paying for a transaction.

In an embodiment of the payment and transaction management system, loyalty program information is exchanged in the same action that provides payment information—both types of information can be exchanged as the payment tag 100 is read. In addition, if the loyalty program allows for customer credit that can be used to pay for merchandise, by paying the with the payment tag 100, those credits are available to the customer by presenting the payment tag 100, just as other sources of payment such as prepayment and ACH funds are made available when the payment tag 100 is presented.

Similarly, in the same process of providing payment information, the payment tag 100 may provide other information to the merchant to expedite a transaction, such as a regular order. For example, if the merchant is a coffee seller, the customer's usual order can be encoded on the payment tag 100 or associated with the customer's record at the host 400 level. Thus, by waiving a payment tag 100, a customer may provide payment information, loyalty program information, and a usual order. In other embodiments, prescription information, allergy information, drug interaction information, and medical insurance information can be encoded to facilitate rapid pharmacy and medical transactions. Customer information provided by the payment tag 100, customer information stored on the host 400, or manifested by the customer's buying habits can be stored and tracked by the system either by name or anonymously to allow the business to better respond to and serve customer needs.

Embodiments of payment system allow for a payment tag 100 to be encoded to default to an ACH transaction, a credit card transaction, a prepaid transaction, or another type of transaction without the customer making a specific selection. Alternatively, for example, the payment tag 100 may be encoded to initiate an ACH transaction for transactions up to a certain threshold amount, but use a credit card account for transactions beyond that amount. Alternatively, the payment tag 100 may be encoded to initiate a particular type of transaction, such as a prepaid transaction, but, if sufficient funds are not available, use a secondary form of payment such as an ACH or credit card transaction to pay for the transaction. Further alternatively, the payment preferences, defaults, and backup payment authorizations may be maintained on the host level in the user data storage 404 accessible by the host 400. The information for each customer is then accessed when the customer's payment tag 100 is presented at the customer terminal.

Communication between the host 400 and the control unit 130 also facilitates remote management, maintenance, and upgrading of point-of-sale systems. For example, the host 400 can monitor the control unit 130 via the communications link 402 to determine if the control unit 130, the customer terminal 110, or other devices at the point of sale have generated any errors. The host 400 may be able to diagnose and repair problems resulting in such errors, inform users of the system that their equipment is malfunctioning, and perform other forms of remote monitoring and maintenance. Furthermore, if a new version of operating or application software becomes available, the host 400 can transmit new software modules downstream via the communications link 402 to update devices at the point of sale to correct software problems, provide new or improved functionality, support new peripheral devices, and provide other similar upgrades.

According to various embodiments of such a transaction system, many other features can be made available. For example, a customer can use a computer 416 to access the host 400 via the Internet 418 to manage his or her account. The customer can use the computer to monitor payment tag 100 usage. In addition, as is further described below, the customer can specify various preferences, such as setting preferences for prepaid, ACH, or credit card payments. The customer also can arrange to assign prepaid funds with a tag. As previously described, the preferences are stored in the user data 404 at the host level where they later can be written to the payment tag 100 or are accessed on demand when the payment tag 100 is presented.

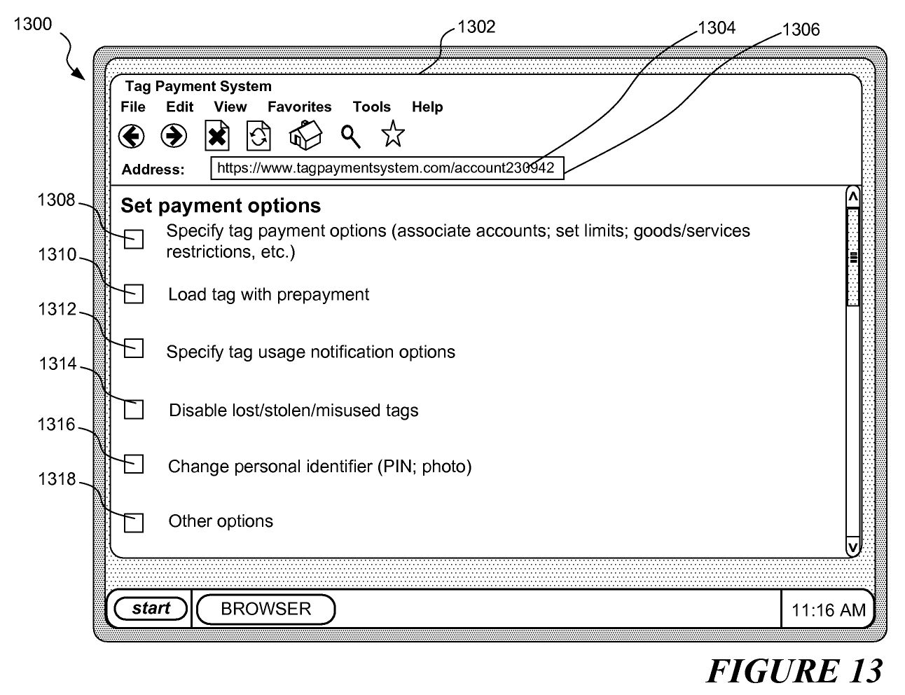

Using the computer 416, the user may also be able to control how a payment tag 100 is used. For example, if the customer is a parent managing a payment tag 100 for a child, the parent may limit how much the tag holder can spend in one transaction, during a single day, during a single month, etc. Alternatively, the parent may specify, for example, that the payment tag 100 may be used to pay for gasoline but nothing else, that the tag may be used for anything but alcohol or tobacco, or set other similar parameters. Similarly, for example, a supervisor managing a payment tag 100 for an employee with a gas allowance may specify that the payment tag 100 can be used to pay for gasoline but nothing else. Alternatively, the supervisor may specify that the payment tag 100 can be used only at certain gas stations with which the firm has previously arranged credit and/or discount terms. Additional possible uses of the computer 416 for account management are described below in connection with FIG. 13.

In addition, the host 400 may be in communication with a telephone system 420 over a network 422 that allows for account usage information to be sent to a customer associated with the payment tag. For example, a customer may specify that he or she wants a confirming text or verbal message sent to his or her mobile phone anytime his or her payment tag is used, or any time another payment tag associated with the customer is used. For example, if a customer receives a message that a transaction has been performed, when the customer does not recall making that transaction, this may alert the customer to check to see if his or her payment tag 100 has been lost or stolen. By replying to the message, the customer may be able to halt further use of the payment tag to protect his or her funds and/or credit history. By way of further example, in monitoring use of a payment tag 100 assigned to a child, a parent may want to receive messages whenever the child uses the payment tag and/or uses the payment tag for a transaction over a predetermined threshold amount.

Further alternatively, if a user elects an ACH transaction, and the transaction was declined for insufficient funds, the host 400 may use the telephone network 420 to send this information to the customer. The customer then can send a reply message to specify an alternative form of payment so that the merchant does not have to charge the customer a penalty for a returned check.

It should also be noted that, instead of receiving messages via a mobile phone, the user might also elect to receive e-mail alerts on a computer 416 via the Internet 418. With the host 400 being able to send and receive information from customers via computer 416 and/or telephone 426, flexible customer control and management of their accounts is made possible.

Transaction Control Provided by the Control Unit

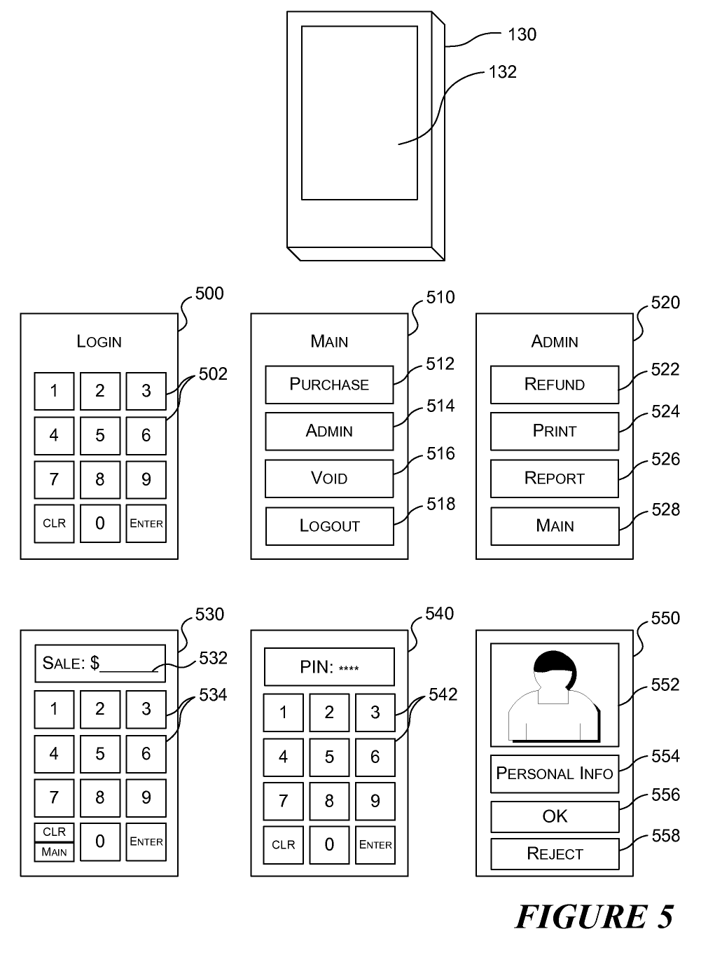

FIG. 5 illustrates how the control unit 130 allows for flexible control of the transaction system. As previously described, in one embodiment, the control unit includes an interactive display 132 that allows for flexible and updatable control of the transaction system. As previously described, one control unit 130 may control a plurality of customer terminals. FIG. 5 shows a number of exemplary display screens to illustrate the availability of these functions.

A login screen 500 requires that a cashier or other operator enter a numeric code, which may include a user identifier, a PIN, and/or provide a thumbprint or other biometric information to control access to the system. As in other systems, ranging from computers to automatic teller machines, requiring a login prevents unauthorized use of the system. In one embodiment, each cashier or other operator may be assigned a unique identifier so that any irregularities in the use of the system may be traced to an individual operator.

A main screen 510 provides a menu of choices for the operator, including a purchase option 512, an admin option 514, a void option 516, and logout option 518. The purchase option 512 allows the operator to initiate an ACH, credit card, or prepaid transaction. The admin option 514 allows the operator to access other functions in managing the system, as is described further below. The operator can void a mistaken transaction using the void option 516. When the operator leaves his or her station, he or she can logout of the system using the logout option 518.

By choosing the admin option 514 from the main menu 510, the operator invokes an admin screen 520. The admin screen 520 presents the operator with a refund option 522, a print option 524, a report option 526, and a main option 528 that returns the system to the main screen 510. It should be noted that the administrative functions might be restricted to use by managers or supervisors to limit other employees from giving refunds or having access to transaction reports.

The refund option 522, which may invoke one or more additional screens (not shown), allows an operator to refund cash or issue a credit to a customer who is not satisfied with a purchase. The print option 522 allows the operator to generate receipts for previous transactions so that, for example, if a customer forgot to elect a receipt or the customer's payment tag is encoded to waive the receipt, the operator can generate one for the customer from a list of most recent transactions. The report option 526 allows the operator to print a transaction report for a specified period, such as at the close of a shift or at the end of the day.

A sale screen 530 allows an operator to enter a transaction amount 532 for a transaction by entering the amount of the transaction using touchkeys 534 presented by the interactive display 532. It should be noted that, if the merchant already has a point-of-sale computing system, the control unit 130 could be configured to communicate with the existing system to have the total passed to the control unit 130 without the transaction amount having to be re-entered.

A PIN screen 540 allows a customer to enter a PIN when a PIN has been associated with a payment tag. A customer may elect to have a PIN associated with the payment tag to prevent unauthorized use of the payment tag.

An alternative form of security may be provided by a validation screen 550. A validation screen presents a photo 552 of one or more authorized users associated with the payment tag. The photo 552 may have been taken at the time the payment tag was issued, or, for example, may be supplied by a user using a computer 416 (FIG. 4). The validation screen 550 also may supply personal information 554 about the customer, such as age, address, and other information that a cashier or other operator can use to verify that the payment tag is not being used improperly. If the operator is satisfied that the customer presenting the payment tag is authorized, the operator can select the OK option 556. On the other hand, if the operator is not satisfied that the person presenting the payment tag is authorized to use the payment tag based on the photo 552 and the personal information 554, the operator can select the reject option 558 to refuse the transaction.

Taking advantage of the flexibility and programmability of the interactive display surface 132, many other functions can be accommodated by the control unit 130. Screens 500-550 are exemplary in nature, and should not be construed as limiting the functions available using the control unit 130.

Functions Provided by the Customer Terminal

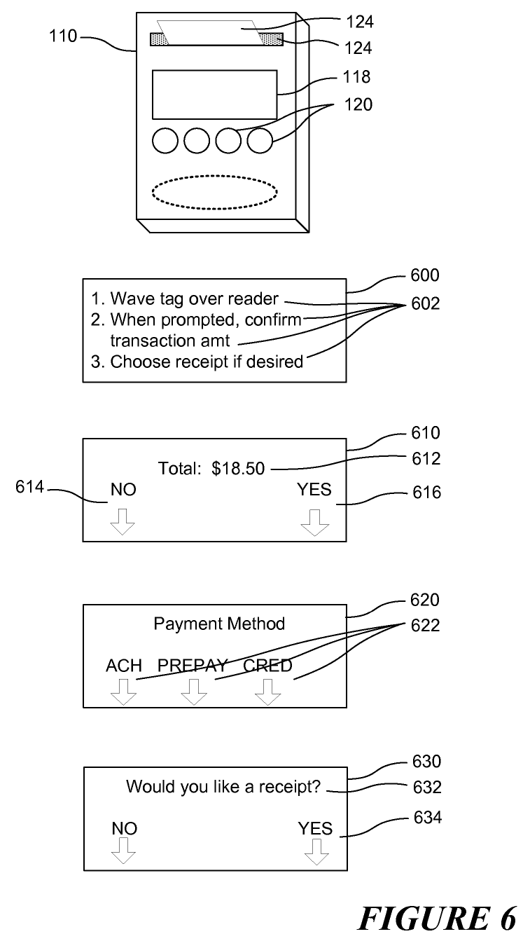

FIG. 6 illustrates how the control unit 110 facilitates customer transactions. The display 118, in concert with the function keys 120, provides the user with control over various aspects of transactions.

An instruction screen 600 provides a number of lines of instruction 602 to instruct or remind a customer how to conduct a transaction using. For example, instruction screen 600 may remind the customer of a sequence of steps involved in paying for a transaction, such as starting by waving the payment tag over the reader.

A confirmation screen 610 reports to the customer the transaction total 612 that is to be charged to the customer via prepay, ACH, or credit card. If the amount is incorrect or the customer decides to abort the transaction, a NO label 614 indicates which of the function keys 120 the customer should select to abort the transaction. On the other hand, if the customer is satisfied that the transaction amount 612 is correct, a YES label 616 indicates which of the function keys 120 the customer should select to authorize the transaction.

Although not shown on the confirmation screen 610 of FIG. 6, the confirmation screen 610 may be adapted to allow a customer to determine and/or add a gratuity. The confirmation screen 610 also suitably may be adapted, to calculate an updated transaction total to include the gratuity. The gratuity functions facilitate use of the control unit 130 in restaurants and other businesses where gratuities are appropriate.

A payment method screen 620 queries the customer as to how the customer wishes to pay for the transaction. The payment screen includes a plurality of labels 622, indicating which of the function keys 120 the customer should select to indicate which of the payment mechanisms associated with the payment tag the customer wishes to use.

A receipt screen 630 presents the question 632 as to whether the customer would like a printed receipt for the transaction. The receipt screen presents labels 634 indicating which of the function keys 120 the customer should choose to decline or request that the printer 122 generate a printed receipt 124.

Taking advantage of the flexibility and programmability of the display 118 and the function keys 120, many other functions can be accommodated by the customer terminal 110. Screens 600-630 are exemplary in nature, and should not be construed as limiting the functions available using the customer terminal 110.

Operation of the Customer Terminal and the Control Unit

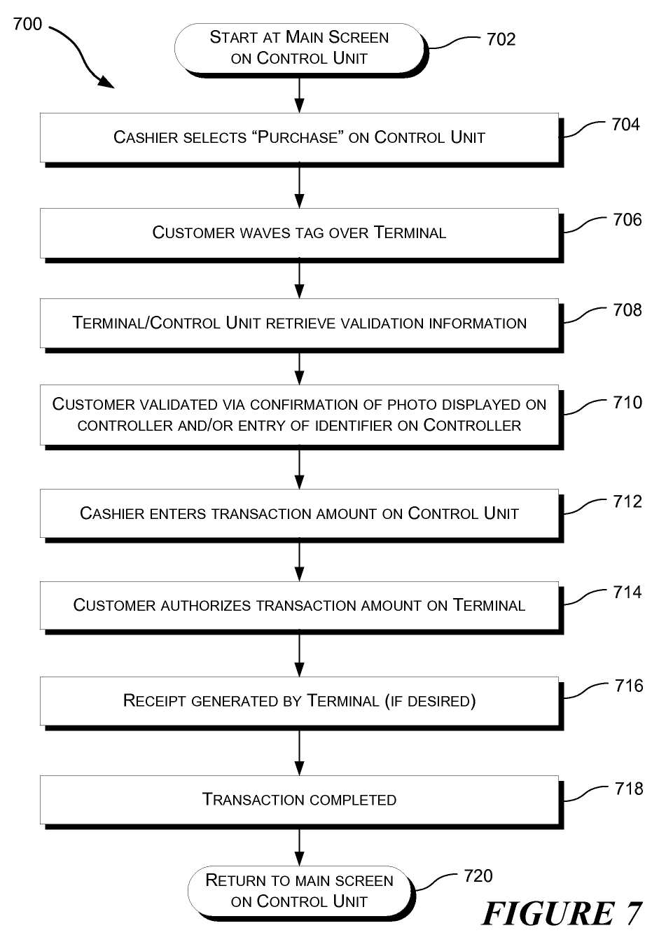

FIGS. 7-12 illustrate operation of the customer terminal and control unit in facilitating customer transactions and reporting functions.

FIG. 7 is a flow diagram 700 illustrating how the customer terminal and control unit are used to process payment for a transaction. At 702, the payment process begins at the main screen on the control unit. At 704, the cashier or other operator chooses the purchase option from the main menu on the controller screen. At 706, the customer waves the payment tag over the customer terminal. At 708, the customer terminal passes the information read from the payment tag to the control unit, and the control unit retrieves validation information from the host as previously described. Thus, for example, if the payment tag has been reported as lost or stolen, the customer has an unpaid balance, or there are other problems with the customer's account, that information will be reported to the operator. Alternatively, if there are no such problems with the customer account, validation information, such as a request for a PIN or an associated photo, are transmitted to the control unit.

At 710, the transaction is validated by the cashier confirming that a photograph presented on the control unit is the person presenting the payment tag, or by the customer entering a valid PIN. Although not shown in FIG. 7, if the transaction cannot be validated, the transaction is terminated at this point.

Assuming the transaction has been validated, at 712, the cashier enters the amount of the transaction on the control unit, or the transaction amount is otherwise communicated to the control unit. At 714, the customer is asked to authorize the amount of the transaction on the customer terminal. At 716, if desired by the customer either as specified by customer information encoded on the tag, stored at the host, or indicated by the customer on the customer terminal, a receipt is generated by the terminal. At 718, the transaction is completed. At 720, the control unit reverts to the main screen to await the next transaction.

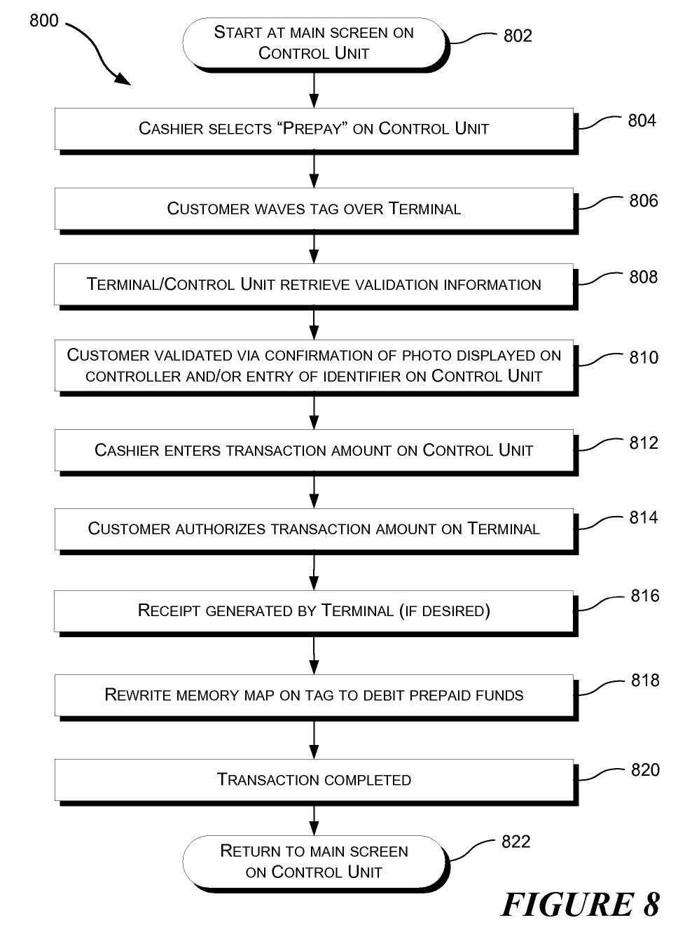

FIG. 8 is a flow diagram 800 illustrating how the customer terminal and control unit are used to process a prepaid transaction. At 802, the payment process begins at the main screen on the control unit. At 804, the cashier or other operator chooses the prepaid purchase option from the main menu on the controller screen. At 806, the customer waves the payment tag over the customer terminal. At 808, the customer terminal passes the information read from the payment tag to the control unit, and the control unit retrieves validation information from the host as previously described.

At 810, the transaction is validated by the cashier confirming that a photograph presented on the control unit is the person presenting the payment tag, or by the customer entering a valid PIN. Although not shown in FIG. 8, if the transaction cannot be validated, the transaction is terminated at this point.

Assuming the transaction has been validated, at 812, the cashier enters the amount of the transaction on the control unit, or the transaction amount is otherwise communicated to the control unit. At 814, the customer is asked to authorize the amount of the transaction on the customer terminal. At 816, if desired by the customer either as specified by customer information encoded on the tag, stored at the host, or indicated by the customer on the customer terminal, a receipt is generated by the terminal. At 818, in one embodiment, the customer presents the payment tag to the reader/writer included in the customer terminal to rewrite the memory map in the payment tag to represent the debited, post-transaction amount of prepaid funds remaining on the payment tag. Although not shown in FIG. 8, alternatively, the amount of available prepaid funds may be logged at the host level instead of rewritten to the payment tag.

At 820, the transaction is completed. At 822, the control unit reverts to the main screen to await the next transaction.

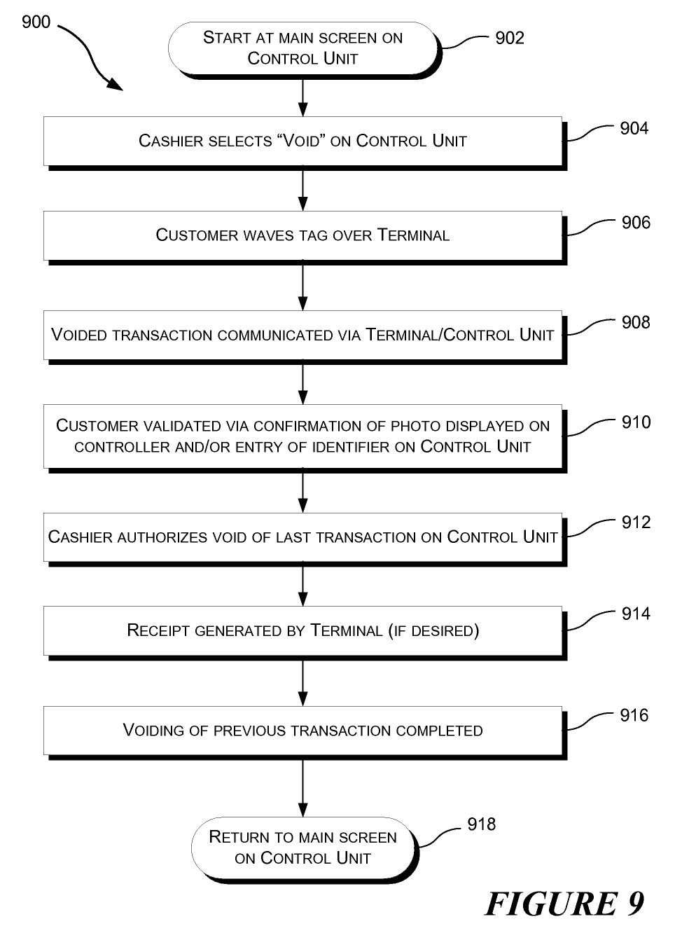

FIG. 9 is a flow diagram 900 illustrating how the customer terminal and control unit are used in voiding payment for a transaction that already has been processed. At 902, the payment process begins at the main screen on the control unit. At 904, the cashier or other operator chooses the void option from the main menu on the controller screen. At 906, the customer waves the payment tag over the customer terminal. At 908, information voiding the transaction is communicated via the customer terminal and control unit to the host to credit the amount of the voided transaction. At 910, the transaction is validated by the cashier confirming that a photograph presented on the control unit is the person presenting the payment tag, or by the customer entering a valid PIN.

Assuming the transaction has been validated, at 912, the cashier authorizes the voiding of the last transaction on the control unit. At 914, if desired by the customer either as specified by customer information encoded on the tag, stored at the host, or indicated by the customer on the customer terminal, a receipt is generated by the terminal. At 918, the voiding of the transaction is completed. At 920, the control unit reverts to the main screen to await the next transaction.

In addition to processing customer transactions, embodiments of the payment method and system also allow various administrative functions to be handled at the point of sale using the customer terminal and the control unit.

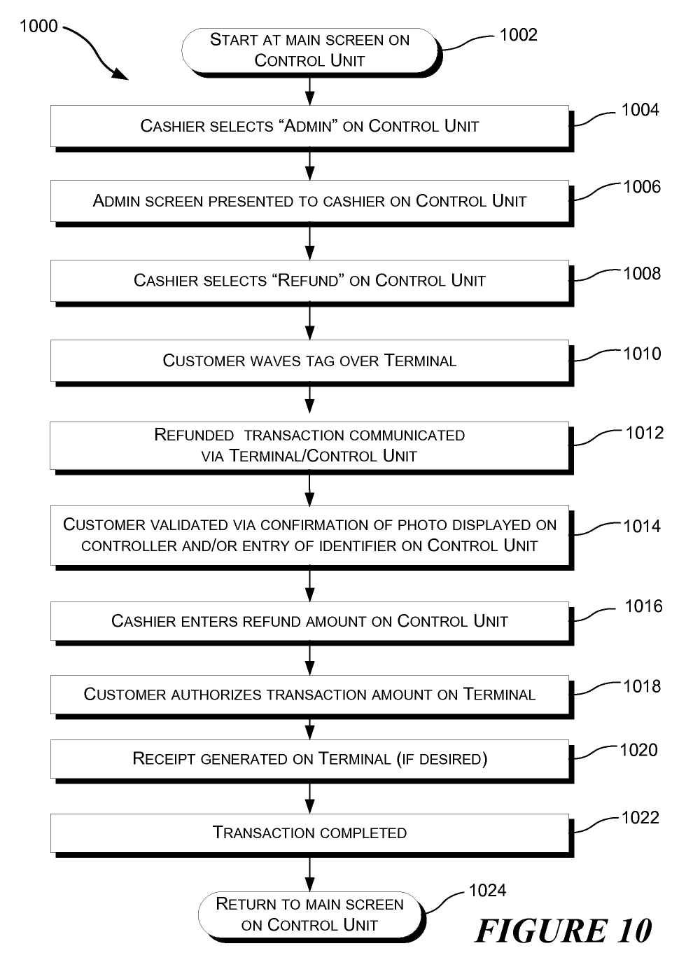

FIG. 10 is a flow diagram 1000 illustrating how the customer terminal and control unit are used to issue a refund to a customer. At 1002, the process begins at the main screen on the control unit. At 1004, the cashier or other operator chooses the admin option from the main menu on the controller screen. At 1006, the admin screen is presented to the cashier or other operator. As previously described, not all users may be authorized to access the admin screen. For example, at many retail businesses, only a manager can issue refunds to customers to provide the retail business with some level of additional security. Once the operator has successfully accessed the admin screen, at 1008, the operator chooses the refund option at the control unit. At 1010 with the customer waves the payment tag over the customer terminal.

At 1012, information regarding refund sought is communicated via the customer terminal and control unit to the host to credit the amount of the refunded transaction. At 1014, the transaction is validated by the cashier confirming that a photograph presented on the control unit is the person presenting the payment tag, or by the customer entering a valid PIN.

Once the transaction has been validated, at 1016, the cashier enters the amount of the refund on the control unit, or the transaction amount is otherwise communicated to the control unit. At 1018, the customer is asked to authorize the amount of the transaction on the customer terminal. At 1020, if desired by the customer either as specified by customer information encoded on the tag, stored at the host, or indicated by the customer on the customer terminal, a receipt is generated by the terminal. At 1022, the refund is completed. At 1024, the control unit reverts to the main screen to await the next transaction.

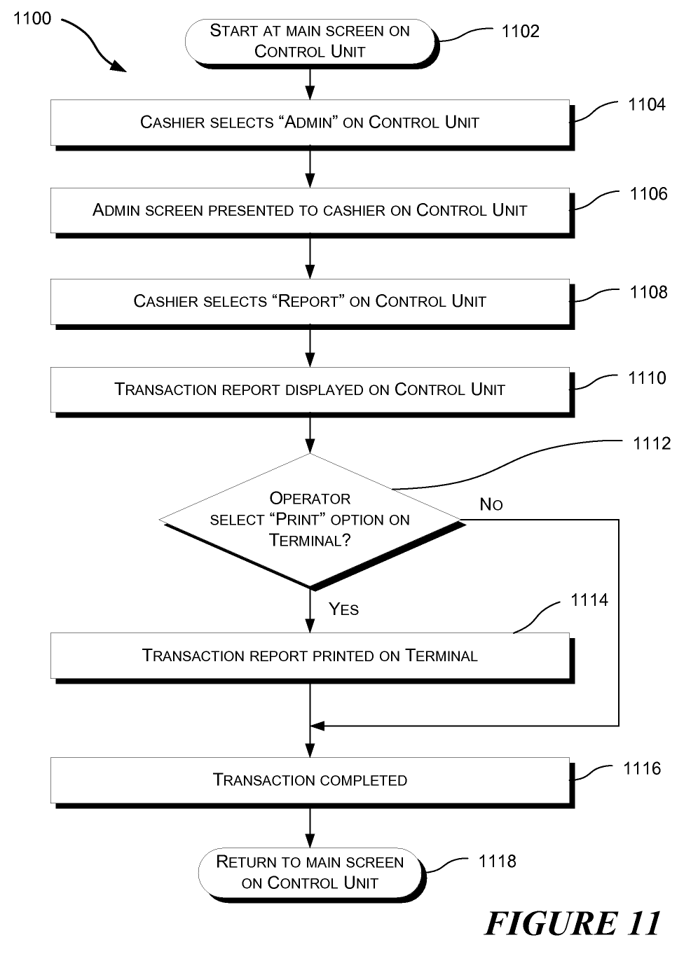

FIG. 11 is a flow diagram 1100 illustrating how the customer terminal and control unit are used to generate periodic transaction reports for the records of the retail business. At 1102, the process begins at the main screen on the control unit. At 1104, the cashier or other operator chooses the admin option from the main menu on the controller screen. At 1106, the admin screen is presented to the cashier or other authorized operator. Once the operator has successfully accessed the admin screen, at 1108, the operator chooses the report option at the control unit. At 1110, the periodic transaction report is displayed on the control unit interactive display.

At 1112, it is determined if the operator has selected a print option on the interactive display. If so, at 1114, the transaction report is printed on the customer terminal's printer. Once the report is printed, or if the operator indicated that he or she did not want to print the report, at 1116, the transaction is completed. At 1118, the control unit reverts to the main screen to await the next transaction.

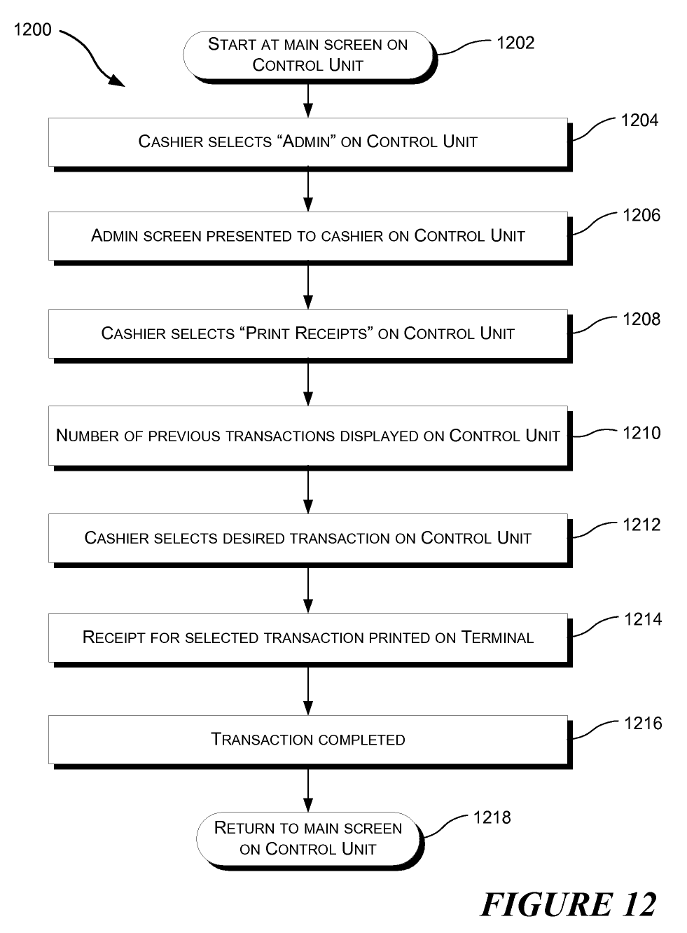

FIG. 12 is a flow diagram 1200 illustrating how the customer terminal and control unit are used to print duplicate receipts for transactions, or to print receipts when no receipt was generated during the original transaction. At 1202, the process begins at the main screen on the control unit. At 1204, the cashier or other authorized operator chooses the admin option from the main menu on the controller screen. At 1206, the admin screen is presented to the cashier or other operator. At 1208, the operator selects the print receipts option on the control unit.

At 1210, a number of previous transactions are displayed on the control unit. At 1212, the operator selects the desired transaction on the interactive display of the control unit. At 1214, a receipt for the specified transaction is printed on the customer terminal. At 1216, the printing transaction is completed. At 1218, the control unit reverts to the main screen to await the next transaction.

Again, many other functions may be implemented on the control unit and customer terminal for processing and managing transactions. The examples described here are illustrative and should not be considered as limiting the methods and systems described.

Setting Payment Tag Options

As previously described in connection with FIG. 4, a customer can manage the use of a payment tag by using a computer to access the payment system over the Internet. FIG. 13 shows an initial screen a customer may access to manage one or more payment tags.

In one embodiment, a customer using a computer connected to the Internet can use a web browser to access the tag payment system via the World Wide Web. Screen 1300 shows a browser window 1302 in which a user has entered a uniform resource locator (URL) 1304 in an address field 1306 to access the tag payment system. Although not shown in FIG. 13, a customer has accessed his or her account by specifying a unique identifier and password to facilitate a secure transaction.

As shown in FIG. 13, a customer can specify a wide range of attributes for controlling his or her account via the Internet. The customer can access attributes for a number of payment tags, including his or her own payment tag, as well as payment tags the customer manages, such as payment tags for his or her employees, children, etc. FIG. 13 illustrates just a few examples.

First, at 1308, a customer can specify tag payment options. Tag payment options include association of bank accounts, credit card accounts, or other sources of funds with the payment tag. A customer can set purchase total limits to restrict how much a user is able spend using the payment tag for a predetermined period. Similarly, the customer can specify goods or services for which the payment tag may or may not be used. These options will be stored at the host and then written to the memory map of the transponder within the payment tag when the payment tag is next presented at a customer terminal. Alternatively, the information may be maintained at a host level to be accessed whenever the payment tag is presented at a customer terminal.

At 1310, a customer can also load a payment tag with prepaid funds. The funds can be drawn from an associated bank account or a credit card. The customer can load funds onto his or her own payment tag, or can load funds onto other payment tags for which the customer is responsible.

At 1312, a customer can specify notification options. As previously described, the customer may specify whether he or she wants to receive a message, such as an e-mail message or mobile phone text message, each time a payment tag is used or when use of a payment tag breaches predetermined thresholds. For example, the customer may specify that he or she wants to be notified each time a payment tag is used for a transaction over a threshold amount. Alternatively, the customer may specify that he or she wants a message each time an attempt is made to use a payment tag for a restricted transaction, such as if the customer's child attempts to use the payment tag to buy tobacco or alcohol.

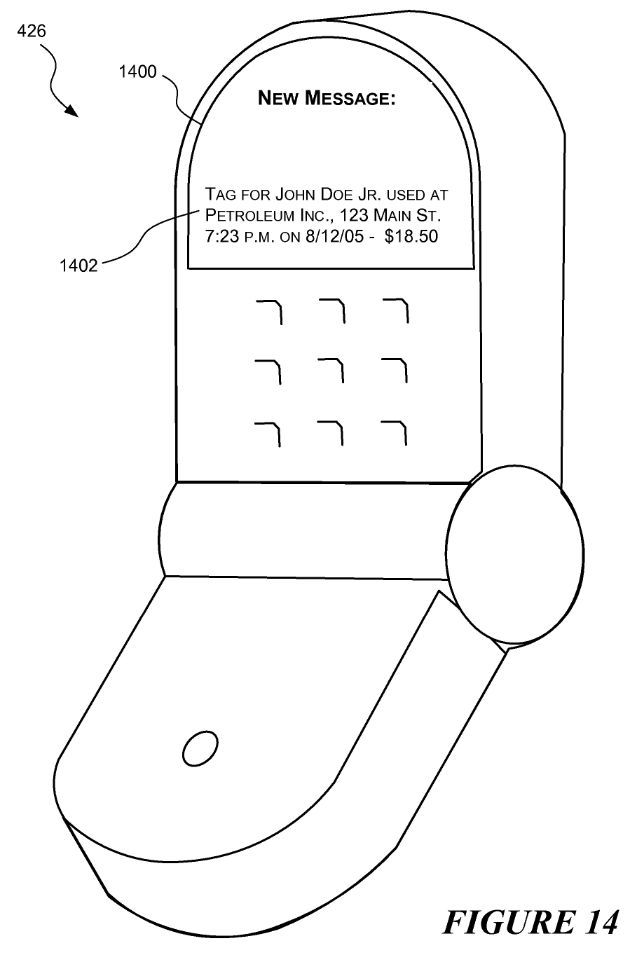

For sake of example, FIG. 14 shows a mobile telephone 426 including a display 1400 that can receive notification messages. As shown in FIG. 14, a message 1402 communicates to the customer associated with a payment tag when and where a payment tag has been used, and the amount of the transaction. Thus, for security and peace of mind, a customer can receive current reports on the use of payments tags with which the customer is associated.

At 1314, a customer alerts the system when his or her payment tag has been lost or stolen. Thus, the customer can stop further use of the payment tag so that someone cannot access prepaid funds associated with the payment tag or access funds via ACH or credit card.

At 1316, a customer can change a personal identifier, such as changing a PIN or providing a photograph to be associated with the payment tag for subsequent transaction verification.

At 1318, a customer can select other options as well. Again, the options a customer can specify or modify listed here are exemplary in nature, and should not be construed as restricting the method and system herein described.

In addition to customer selectable payment options, it should be appreciated that merchants similarly can specify and modify what options they may place on the use of payment tags. For example, a merchant or other payment tag provider may place a limit on purchases that can be made using a prepaid tag unless a valid, backup credit card account is associated with the payment tag.

Computing System for Implementing Exemplary Embodiments

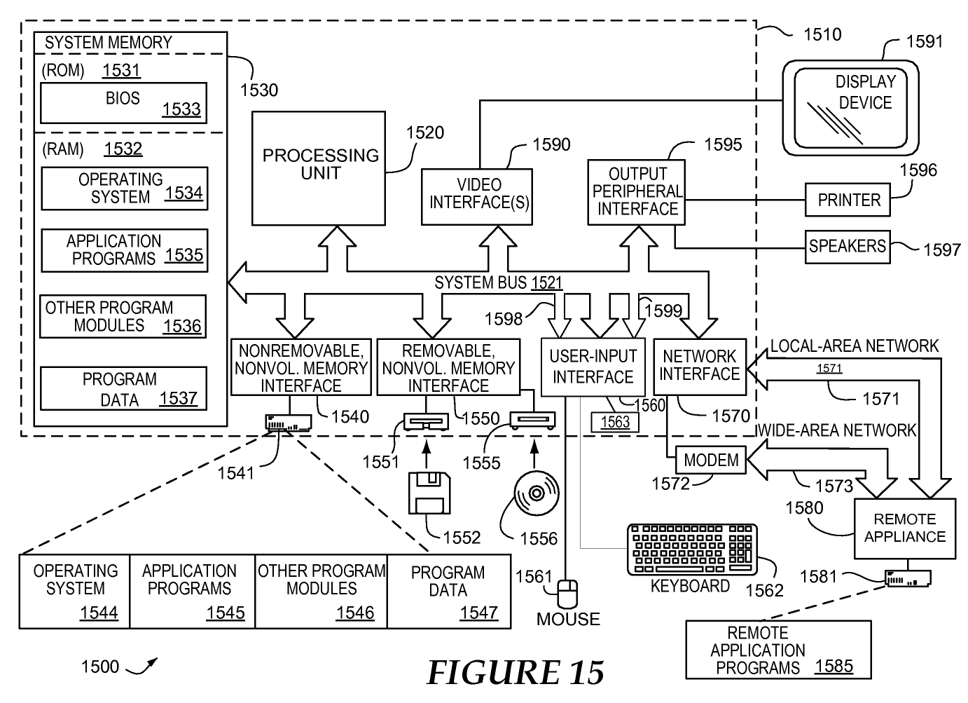

FIG. 15 illustrates an exemplary computing system 1500 for implementing embodiments of the payment and transaction management system. Instead of using the customer terminal and control unit shown, the payment and transaction management system can be supported by a general-purpose computing system. Similarly, as previously described, a general-purpose computing system may be used by a customer to modify or specify payment options.

The computing system 1500 is only one example of a suitable operating environment and is not intended to suggest any limitation as to the scope of use or functionality of exemplary embodiments of the payment and transaction management process previously described or other embodiments. Neither should the computing system 1500 be interpreted as having any dependency or requirement relating to any one or combination of components illustrated in the exemplary computing system 1500.

The payment and transaction management process may be described in the general context of computer-executable instructions, such as program modules, being executed on computing system 1500. Generally, program modules include routines, programs, objects, components, data structures, etc., that perform particular tasks or implement particular abstract data types. Moreover, those skilled in the art will appreciate that the payment and transaction management process may be practiced with a variety of computer-system configurations, including hand-held devices, multiprocessor systems, microprocessor-based or programmable-consumer electronics, minicomputers, mainframe computers, and the like. The payment and transaction management process may also be practiced in distributed-computing environments where tasks are performed by remote-processing devices that are linked through a communications network. In a distributed-computing environment, program modules may be located in both local and remote computer-storage media including memory-storage devices.

With reference to FIG. 15, an exemplary computing system 1500 for implementing the payment and transaction management process includes a computer 1510 including a processing unit 1520, a system memory 1530, and a system bus 1521 that couples various system components including the system memory 1530 to the processing unit 1520.

Computer 1510 typically includes a variety of computer-readable media. By way of example, and not limitation, computer-readable media may comprise computer-storage media and communication media. Examples of computer-storage media include, but are not limited to, Random Access Memory (RAM); Read Only Memory (ROM); Electronically Erasable Programmable Read Only Memory (EEPROM); flash memory or other memory technology; CD ROM, digital versatile discs (DVD) or other optical or holographic disc storage; magnetic cassettes, magnetic tape, magnetic disk storage or other magnetic storage devices; or any other medium that can be used to store desired information and be accessed by computer 1510. The system memory 1530 includes computer-storage media in the form of volatile and/or nonvolatile memory such as ROM 1531 and RAM 1532. A Basic Input/Output System 1533 (BIOS), containing the basic routines that help to transfer information between elements within computer 1510 (such as during start-up) is typically stored in ROM 1531. RAM 1532 typically contains data and/or program modules that are immediately accessible to and/or presently being operated on by processing unit 1520. By way of example, and not limitation, FIG. 15 illustrates operating system 1534, application programs 1535, other program modules 1536, and program data 1537.

The computer 1510 may also include other removable/nonremovable, volatile/nonvolatile computer-storage media. By way of example only, FIG. 15 illustrates a hard disk drive 1541 that reads from or writes to nonremovable, nonvolatile magnetic media, a magnetic disk drive 1551 that reads from or writes to a removable, nonvolatile magnetic disk 1552, and an optical-disc drive 1555 that reads from or writes to a removable, nonvolatile optical disc 1556 such as a CD-ROM or other optical media. Other removable/nonremovable, volatile/nonvolatile computer-storage media that can be used in the exemplary operating environment include, but are not limited to, magnetic tape cassettes, flash memory units, digital versatile discs, digital video tape, solid state RAM, solid state ROM, and the like. The hard disk drive 1541 is typically connected to the system bus 1521 through a nonremovable memory interface such as interface 1540. Magnetic disk drive 1551 and optical dick drive 1555 are typically connected to the system bus 1521 by a removable memory interface, such as interface 1550.

The drives and their associated computer-storage media discussed above and illustrated in FIG. 15 provide storage of computer-readable instructions, data structures, program modules and other data for computer 1510. For example, hard disk drive 1541 is illustrated as storing operating system 1544, application programs 1545, other program modules 1546, and program data 1547. Note that these components can either be the same as or different from operating system 1534, application programs 1535, other program modules 1536, and program data 1537. Typically, the operating system, application programs, and the like that are stored in RAM are portions of the corresponding systems, programs, or data read from hard disk drive 1541, the portions varying in size and scope depending on the functions desired. Operating system 1544, application programs 1545, other program modules 1546, and program data 1547 are given different numbers here to illustrate that, at a minimum, they can be different copies. A user may enter commands and information into the computer 1510 through input devices such as a keyboard 1562; pointing device 1561, commonly referred to as a mouse, trackball or touch pad; a wireless-input-reception component 1563; or a wireless source such as a remote control. Other input devices (not shown) may include a microphone, joystick, game pad, satellite dish, scanner, or the like. These and other input devices are often connected to the processing unit 1520 through a user-input interface 1560 that is coupled to the system bus 1521 but may be connected by other interface and bus structures, such as a parallel port, game port, IEEE 1394 port, or a universal serial bus (USB) 1598, or infrared (IR) bus 1599. As previously mentioned, input/output functions can be facilitated in a distributed manner via a communications network.

A display device 1591 is also connected to the system bus 1521 via an interface, such as a video interface 1590. Display device 1591 can be any device to display the output of computer 1510 not limited to a monitor, an LCD screen, a TFT screen, a flat-panel display, a conventional television, or screen projector. In addition to the display device 1591, computers may also include other peripheral output devices such as speakers 1597 and printer 1596, which may be connected through an output peripheral interface 1595.

The computer 1510 will operate in a networked environment using logical connections to one or more remote computers, such as a remote computer 1580. The remote computer 1580 may be a personal computer, and typically includes many or all of the elements described above relative to the computer 1510, although only a memory storage device 1581 has been illustrated in FIG. 15. The logical connections depicted in FIG. 15 include a local-area network (LAN) 1571 and a wide-area network (WAN) 1573 but may also include other networks, such as connections to a metropolitan-area network (MAN), intranet, or the Internet.

When used in a LAN networking environment, the computer 1510 is connected to the LAN 1571 through a network interface or adapter 1570. When used in a WAN networking environment, the computer 1510 typically includes a modem 1572 or other means for establishing communications over the WAN 1573, such as the Internet. The modem 1572, which may be internal or external, may be connected to the system bus 1521 via the network interface 1570, or other appropriate mechanism. Modem 1572 could be a cable modem, DSL modem, or other broadband device. In a networked environment, program modules depicted relative to the computer 1510, or portions thereof, may be stored in the remote memory storage device. By way of example, and not limitation, FIG. 15 illustrates remote application programs 1585 as residing on memory device 1581. It will be appreciated that the network connections shown are exemplary, and other means of establishing a communications link between the computers may be used.

Although many other internal components of the computer 1510 are not shown, those of ordinary skill in the art will appreciate that such components and the interconnections are well known. For example, including various expansion cards such as television-tuner cards and network-interface cards within a computer 1510 is conventional. Accordingly, additional details concerning the internal construction of the computer 1510 need not be disclosed in describing exemplary embodiments of the payment and transaction management process.

When the computer 1510 is turned on or reset, the BIOS 1533, which is stored in ROM 1531, instructs the processing unit 1520 to load the operating system, or necessary portion thereof, from the hard disk drive 1541 into the RAM 1532. Once the copied portion of the operating system, designated as operating system 1544, is loaded into RAM 1532, the processing unit 1520 executes the operating system code and causes the visual elements associated with the user interface of the operating system 1534 to be displayed on the display device 1591. Typically, when an application program 1545 is opened by a user, the program code and relevant data are read from the hard disk drive 1541 and the necessary portions are copied into RAM 1532, the copied portion represented herein by reference numeral 1535.

Conclusion

Although exemplary embodiments have been described in language specific to structural features and/or methodological acts, it is to be understood that the appended claims are not necessarily limited to the specific features or acts previously described. Rather, the specific features and acts are disclosed as exemplary embodiments.

1. A computer implemented method, comprising:
storing security information in a transponder for an individual associated with the transponder; and
providing for the security information to be accessible from within the transponder at a point-of-sale, such that the security information is verifiable by one of:
the individual confirming the security information stored in the transponder; and
another party verifying that the security information stored in the transponder corresponds with a person presenting the transponder to verify that the person is the individual associated with the transponder.
